(19) United States
(12) Patent Application Publication
(10) Pub. No.: US 2008/0072499 A1
(43) Pub. Date: Mar. 27, 2008

(54) Door exhibit case

(76) Inventor: Peter Sibbett, Augusta, WA (US)

Correspondence Address: LAHIVE & COCKFIELD, LLP, ONE POST OFFICE SQUARE, BOSTON, MA, 02109-2127, US

(21) Appl. No.: 11/638,749

(22) Filed: Dec. 14, 2006

(30) Foreign Application Priority Data
Sep. 27, 2006 (KR) 2006-0094353

(51) Int. Cl. B60J 1/14

(52) U.S. Cl. 49/374

(57) ABSTRACT

Disclosed is a door exhibit case for either exhibiting or displaying doors. The door comprises a frame body, a plurality of guide rails, and a plurality of rotary units. The frame body has a door receiving space capable of receiving a plurality of doors within the interior thereof, wherein the received doors are capable of being extracted through at least one of front and rear sides of the frame body. The guide rails are formed on the inner top surface of the frame body and extend in the front-to-rear direction. Each sliding bar is supported by one guide rail so as to be extracted to the outside of the frame body through the front or rear side of the frame body. Each rotary unit has opposite ends, one end being connected to the bottom surface of a corresponding sliding bar and the other end being connected to the top surface of a corresponding door.

### RELATED APPLICATION

This application claims convention priority to Korean patent application No. 2006-0094353 filed on Sep. 27, 2006, the content of which is incorporated by reference.

### BACKGROUND OF THE INVENTION

1. Field of the Invention

The present invention relates to an apparatus for exhibiting doors, and in particular to a door exhibit case with a novel construction adapted to be capable of being moved to various places and to selectively display at least one specific door among a plurality of doors in such a way that the entire area of the displayed door can be selectively viewed from a same position.

2. Description of the Prior Art

In general, doors are employed so as to open and close various entrances and are formed in various shapes from various materials according to the installed positions or applications thereof.

Recently, such a door is not only employed for use in opening and closing an entrance but is also applied as a kind of indoor furniture. As a result, the design of the external appearance of such a door becomes more important.

Therefore, recently, when a building is constructed, doors are selected in consideration of the design of the interior of the building rather than merely as entrance doors.

In particular, a user (a building owner, a building contractor, or a resident of a corresponding building) may directly select such doors. In that event, it is possible to select one or more doors after seeing a pamphlet or directly seeing the actual products.

However, when buying doors selected through a pamphlet, there is a problem in that there may be a considerable difference in color and shape between the contents printed in the pamphlet and the actual doors, which may cause user's dissatisfaction.

When buying doors selected after seeing the actual products, user's dissatisfaction may be minimized. In such a case, however, there is a problem in that a sufficiently large space is required for exhibiting various doors and it is difficult to carry various doors.

### SUMMARY OF THE INVENTION

Accordingly, the present invention has been made to solve the above-mentioned problems occurring in the prior art, and an object of the present invention is to provide a door exhibit case of a novel construction adapted to be capable of being moved to various places and to selectively display at least one specific door among a plurality of doors in such a way that the entire area of the displayed door can be selectively viewed from the same position.

In order to achieve the above-mentioned objects, there is provided a door exhibit case comprising: a frame body having a door receiving space capable of receiving a plurality of doors within the interior thereof, the received doors being capable of being extracted through at least one of front and rear sides of the frame body; a plurality of guide rails formed on an inner top surface of the frame body and extending in the front-to-rear direction; a plurality of sliding bars, each of which is supported by one guide rail so as to be extracted to the outside of the frame body through the front or rear side of the frame body; and a plurality of rotary units, each of which has opposite ends, one end being connected to the bottom surface of a corresponding sliding bar and the other end being connected to the top surface of a corresponding door.

Here, the guide rails may enclose the outer surfaces of the sliding bars, respectively. The central area of the bottom of each guide rail is slit in the longitudinal direction so as to form an opening for allowing a corresponding rotary unit to be freely moved.

In addition, each sliding bar and each guide rail may further comprise extraction distance limit means for limiting the extraction distance of the guide rail.

At this time, the extraction distance limit means may be configured so as to allow the sliding bar to be extracted by a predetermined length for allowing the rotation of a corresponding door.

Preferably, the extraction distance limit means is configured so as to prevent the sliding bar from coming out.

The extraction distance limit means may comprise: a stopper formed on the guide rail at an sliding bar extraction end, the stopper projecting to such an extent that it does not affect the movement of the sliding bar; and a prominence inwardly projecting from the rear end of the sliding bar, so that the prominence is selectively engaged with the stopper.

In addition, the door exhibit case may further comprise at least one partition plate within the interior of the frame body, so that the door receiving space is divided into two or more parts.

Furthermore, the door exhibit case may further comprise anti-rotation means formed on the inner bottom surface of the frame body for preventing the respective doors from being rotated while being moved.

At this time, the anti-rotation means may comprise a plurality of guide grooves formed on the inner bottom surface of the frame body along the front-to-rear direction of the frame body. The bottom portions of the doors are introduced into the guide grooves, respectively.

In addition, the door exhibit case may further comprise a plurality of wheels provided on the outer bottom surface of the frame body so as to render the frame body movable.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view presented so as to describe an external construction of a door exhibit case according to a preferred embodiment of the present invention;

FIG. 2 is a schematic perspective view of a main part so as to describe a state in which a door is connected to a door exhibit case according to a preferred embodiment of the present invention;

FIG. 3 is a schematic sectional view of a main part so as to describe a state in which a door is connected to a door exhibit case according to a preferred embodiment of the present invention;

FIG. 4 is a schematic perspective view of a main part presented so as to describe a construction of an anti-rotation part of a door exhibit case according to a preferred embodiment of the present invention; and

FIGS. 5 to 7 are perspective views presented so as to describe how to draw out one or more doors from a door exhibit case according to a preferred embodiment of the present invention.

### DETAILED DESCRIPTION OF THE PREFERRED EMBODIMENTS

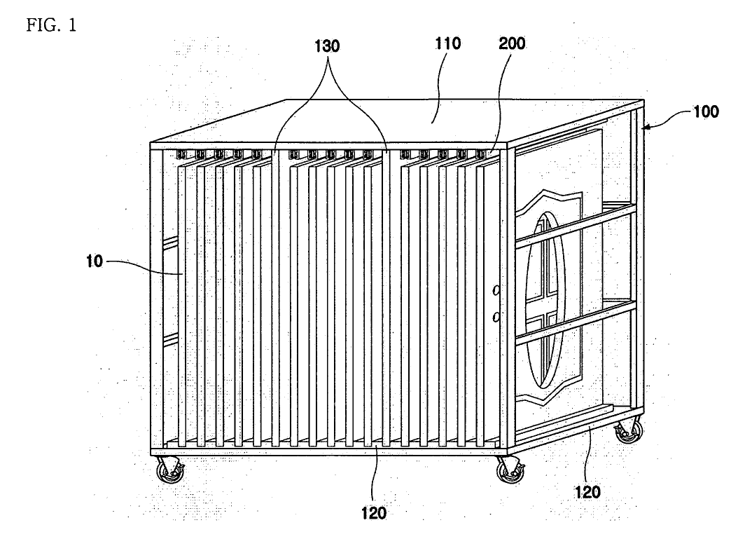

Hereinafter, a preferred embodiment of the present invention will be described in more detail with reference to FIGS. 1 to 7. In the following description and drawings, the same reference numerals are used to designate the same or similar components.

At first, a door exhibit case according to an embodiment of the present invention is constructed to be capable of being moved to various places and selectively displaying at least one specific door among a plurality of doors 10 in such a way that the entire area of the displayed door 10 can be selectively viewed from the same position.

For this purpose, according to an embodiment of the present invention presents, the door exhibit door includes a frame body 100, a plurality of guide rails 200, a plurality of sliding bars 300, and a plurality of rotary units 400. In connection with the door exhibit case, the above-mentioned components are separately described.

As shown in FIG. 1, the frame body 100 forms the body of the door exhibit case, within which a plurality of doors 10 are received.

The frame body 100 is formed in a rectangular parallelepiped shape, in which at least one of front and rear sides of the frame body 100 is opened so that each of the doors 10 can be extracted.

In particular, according to the present embodiment, only the front side of the frame body 100 is completely opened, so that each of the doors 10 can be extracted through the opened front side.

In addition, the frame body 100 includes a top plate 110 and a bottom plate 120, wherein the top plate 110 forms the top wall of the frame body 100 and the bottom plate 120 forms the bottom wall of the frame body 100. Of course, the top plate 100 may be omitted.

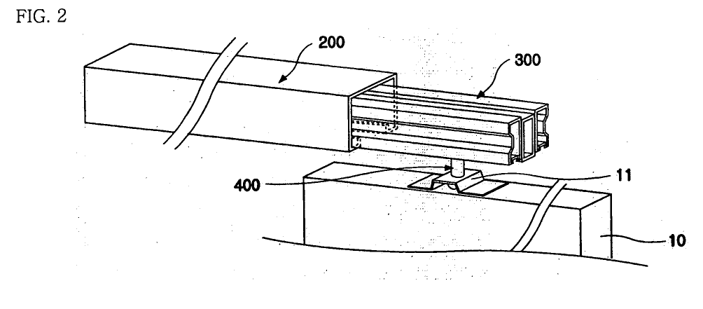

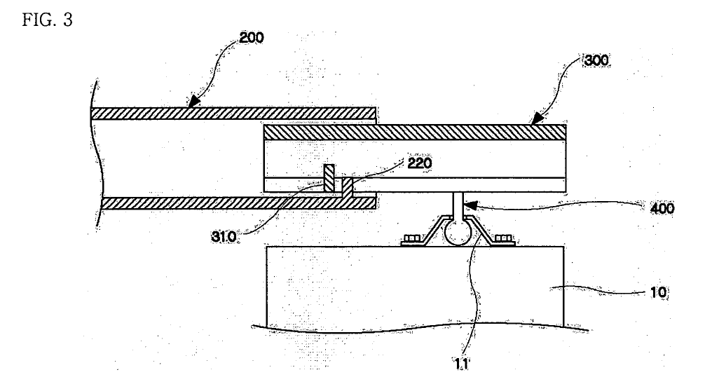

Next, as shown in FIGS. 2 and 3, the above-mentioned guide rails 200 are provided so as to ensure that the doors 10 can be stably extracted.

The guide rails 200 extend in the front-to-rear direction on the bottom surface of the top plate 110. Although not shown in the drawings, unless the top plate 110 is provided for the frame body 100, the guide rails 200 are directly anchored to the top of the frame body 100.

In addition, each of the guide rails 200 is formed from a hollow rectangular cross-sectional pipe. In that event, the central area of the bottom wall of each guide rail 200 is slit along the longitudinal direction thereof, and a rotary unit 400 is introduced through the slit area.

Next, as shown in FIGS. 2 and 3, the sliding bars 300 are provided so as to slidably support the doors 10, respectively.

Each of the sliding bars 300 is supported by a guide rail 200 in such a way that it can be extracted to the outside of the door exhibit case through the opened front side (or rear side) of the frame body 100.

In particular, each of the guide rails 200 is provided with one sliding bar 300 as described above, wherein the sliding bar 300 is introduced into the guide rail 200 to be movable in the longitudinal direction of the guide rail 200. That is, the guide rail 200 encloses the outer surface of the sliding bar 200.

At this time, there are provided one or more rollers or bearings (not shown) on one of contact surfaces between the guide rail 200 and the sliding bar 300 so as to ensure the smooth sliding of the sliding bar 300.

In addition, there may be preferably further provided extraction distance limit means on the guide rail 200 and/or the sliding bar 300. The extraction distance limit means is provided so as to limit the extraction distance of the sliding bar 300, thereby preventing the sliding bar 300 from being extracted over a predetermined extraction distance, so that the sliding bar 300 is prevented from coming off.

The extraction distance limit means includes a stopper 220 projecting from an extraction end (outlet end) in the guide rail 200, through which the sliding bar 300 is extracted, and a prominence 310 inwardly projecting from the rear end of the sliding bar 300 so that the prominence 310 is engaged with the stopper 220, thereby preventing the additional extraction of the sliding bar 300. Preferably, the stopper 220 projects to such an extent that the stopper does not affect the movement of the sliding bar 300.

Of course, it is also possible to form the stopper 220 on the sliding bar 300 and the prominence 310 on the guide rail 200 so as to limit the extraction distance of the sliding bar 300.

Next, as can be seen from FIGS. 2 and 3, the rotary unit 400 serves to allow a corresponding door 10 to be suspended from and to be freely rotated in relation to a corresponding sliding bar 300.

Each sliding bar 300 is provided with a rotary unit 400 as mentioned above, wherein one end of the rotary unit 400 is attached to the bottom surface of the sliding bar 300 and the other end is attached to the top surface of a corresponding door 10.

In addition, a separate bracket 11 is attached on the top surface of the door 10, and the bottom end of the rotary unit 400 is introduced into and engaged with the bracket 11. This arrangement is provided so as to allow the door to be freely rotated in relation to the rotary unit.

Of course, at least one of the ends of the rotary unit 400 may be rotatably configured so as to allow the door to be freely rotated in relation to the sliding bar 300.

Meanwhile, the door exhibit case according to the present embodiment may be additionally provided with at least one partition plate 130 within the inner side of the frame body 100 as shown in FIG. 1.

The at least one partition plate 130 is provided so as to divide the receiving space within the frame body into at least two portions.

The frame body 100 forming the door exhibit case according to the present embodiment further includes anti-rotation means.

Such anti-rotation means are provided so as to prevent the rotation of the doors 10 while supporting the movement of the doors when they are moved so as to be extracted from or introduced into the frame body 100.

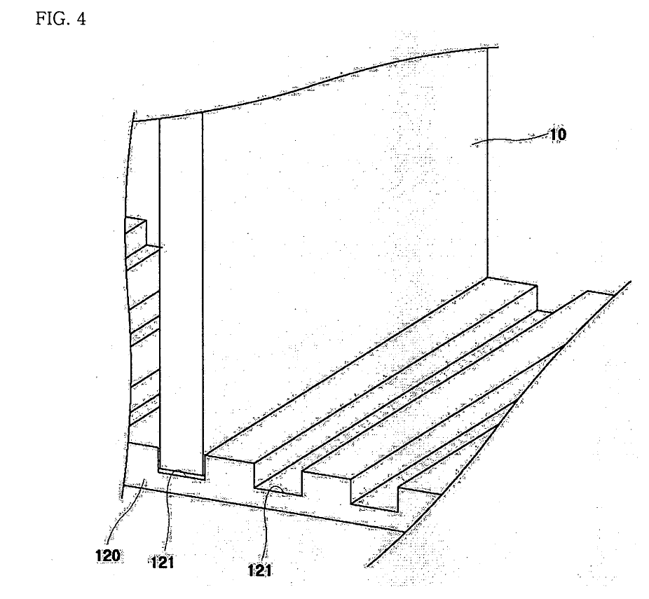

As shown in FIG. 4, the anti-rotation means may be formed by guide grooves 121 extending in the front-to-rear direction on the top surface of the bottom plate 120 of the frame body 100, the bottom portions of the doors 100 being inserted into guide grooves 121, respectively.

Now, a procedure for using the above-mentioned door exhibit case is described with reference to FIGS. 1, 5 and 6.

Firstly, in a conventional storage condition as shown in FIG. 1, doors 10 are maintained in a condition received in the door receiving space within the frame body 100.

The doors 10 may be different from each other in design and/or color.

If a customer wishes to confirm a certain one among the above-mentioned doors 100, the corresponding door 10 is extracted in front of the frame body 100, so that the corresponding door 10 is extracted to the outside of the door exhibit case through the opened front side of the frame body 100.

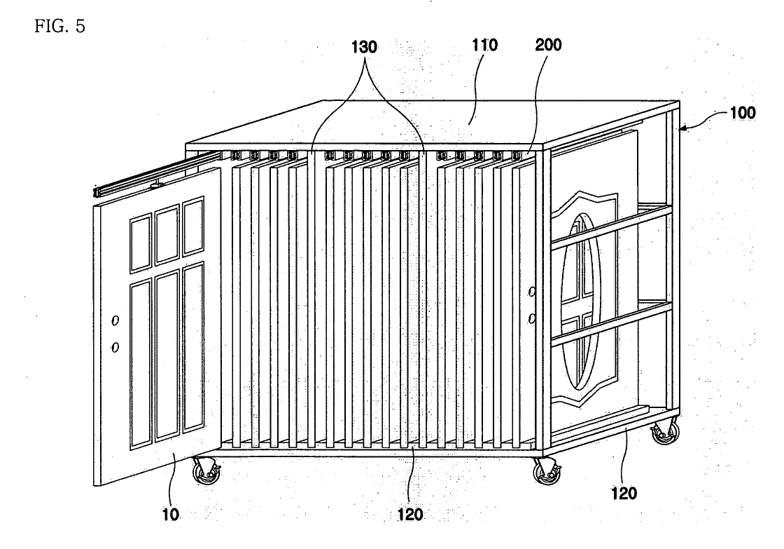

As such, a sliding bar 300 connected to the top surface of the door 10 via a rotary unit 400 is extracted from the corresponding guide rail 200. Consequently, the door 10 is completely extracted to the outside of the door receiving space of the frame body 100 as shown in FIG. 5.

At this time, because the extraction distance of the sliding bar 300 is limited by the extraction distance limit means (i.e., a stopper and a prominence) formed on the sliding bar 300 and the guide rail 200, respectively, the door 10 cannot be further extracted if it is completely extracted from the door receiving space of the frame body 100. That is, if the sliding bar 300, is extracted from the guide rail 200 by a predetermined extraction distance, the prominence 310 formed on the sliding bar 300 or the guide rail 200 is engaged with the stopper formed on the guide rail 200 or the sliding bar, thereby preventing the sliding bar 300 from being further extracted.

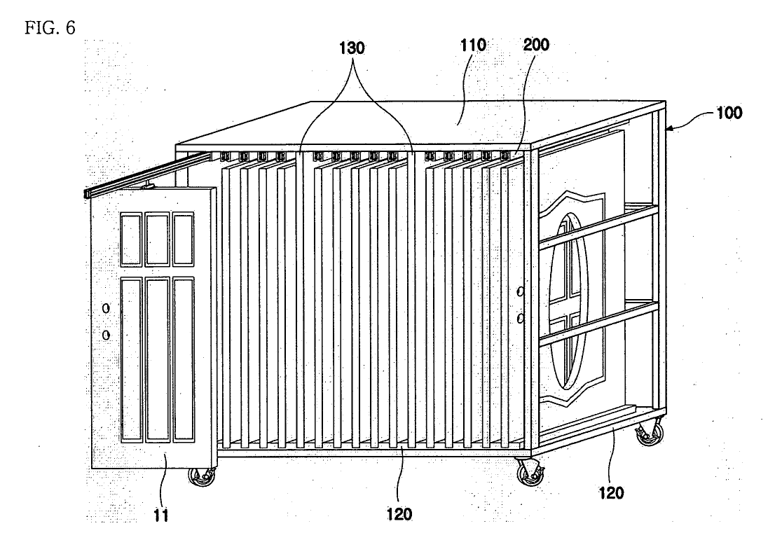

In particular, the door 10 completely extracted from the frame body 100 is placed in a rotatable position, whereby a customer can confirm the entire area of the door 10 as desired while rotating the door 10. This is shown in FIG. 6.

If the customer wishes to confirm another door 10 among the doors 10 exhibited in the door exhibit case, the customer rotates the extracted door 10 to a position where the extracted door is capable of being introduced into the door receiving space and then pushed to its original position within in the door receiving position. Next, the customer extracts another door 10 from the door exhibit case through the same procedure as described above and confirms the door while rotating it.

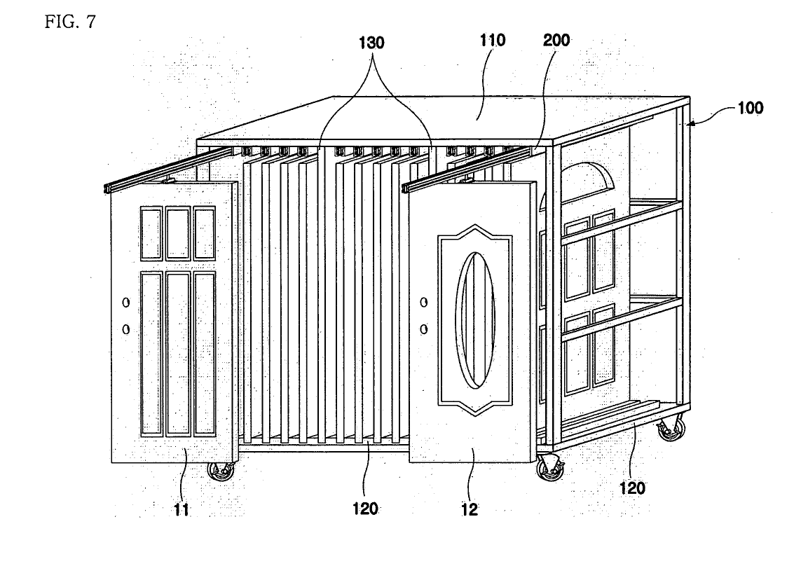

If two doors 11 and 12 are positioned so that one door 11 does not interfere with the rotation of another door 12 as shown in FIG. 7, it is of course possible to extract and display the door 12 in a state in which the door 10 has already been extracted and displayed.

Meanwhile, it is not necessary to configure the inventive door exhibit case in the shape of the above-mentioned embodiment.

For example, although not shown in the drawings, the inventive door exhibit case can be configured in such a way that each guide rail 200 is arranged on the top surface of the bottom plate 120 of the frame body 100 and each sliding bar 300 and each rotary unit 400 are attached to the bottom surface of each door 10.

In addition, it is not necessary to form the anti-rotation means by simple guide grooves 121. That is, although not shown in the drawings, an anti-rotation means may be formed from a pair of projections upwardly projecting from the top surface of the bottom plate 120 of the frame body 100 so that they abut against the opposite surfaces of a door 10, respectively.

The above-mentioned inventive door exhibit case has various effects as described below:

i) the inventive door exhibit case allows various kinds of doors to be exhibited and displayed;

ii) the inventive door exhibit case allows a certain door to be selectively extracted and displayed among the doors according to a customer's desire, so that the customer can view the entire area of a selected door at a position while rotating the door;

iii) the inventive door exhibit case allows the doors to be stored or extracted without coming into contact with each other, thereby preventing unexpected damage of a door which may be caused as the doors come into contact with each other; and

iv) the inventive door exhibit case is freely movable.

Although several preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A door exhibit case comprising:
a frame body having a door receiving space capable of receiving a plurality of doors within the interior thereof, the received doors being capable of being extracted through at least one of front and rear sides of the frame body;
a plurality of guide rails formed on an inner top surface of the frame body and extending in the front-to-rear direction;
a plurality of sliding bars, each of which is supported by one guide rail so as to be extracted to the outside of the frame body through the front or rear side of the frame body; and
a plurality of rotary units, each of which has opposite ends, one end being connected to the bottom surface of a corresponding sliding bar and the other end being connected to the top surface of a corresponding door.

2. A door exhibit case as claimed in claim 1, wherein the guide rails enclose the outer surfaces of the sliding bars, respectively, the central area of the bottom of each guide rail being slit in the longitudinal direction so as to form an opening for allowing a corresponding rotary unit to be freely moved.

3. A door exhibit case as claimed in claim 1, further comprising extraction distance limit means formed in each sliding bar and each guide rail for limiting the extracted distance of the guide rails.

4. A door exhibit case as claimed in claim 3, wherein the extraction distance limit means is configured so as to allow the sliding bars to be extracted by a predetermined length for allowing the rotation of the doors.

5. A door exhibit case as claimed in claim 3, wherein the extraction distance limit means is configured so as to prevent the sliding bars from coming out.

6. A door exhibit case as claimed in claim 3, wherein the extraction distance limit means comprises:
a stopper formed on a guide rail at an sliding bar extraction end, the stopper projecting to such an extent that it does not affect the movement of the sliding bar; and
a prominence inwardly projecting from the rear end of the sliding bar, so that the prominence is selectively engaged with the stopper.

7. A door exhibit case as claimed in claim 1, further comprising at least one partition plate within the interior of the frame body, so that the door receiving space is divided into two or more parts.

8. A door exhibit case as claimed in claim 7, further comprising anti-rotation means formed on the inner bottom surface of the frame body for preventing the respective doors from being rotated while being moved.

9. A door exhibit case as claimed in claim 8, wherein the anti-rotation means comprises a plurality of guide grooves formed on the inner bottom surface of the frame body along the front-to-rear direction of the frame body, the bottom portions of the doors being introduced into the guide grooves, respectively.

10. A door exhibit case as claimed in claim 8, further comprising a plurality of wheels provided on the outer bottom surface of the frame body so as to render the frame body movable.

11. A door exhibit case as claimed in claim 7, further comprising a plurality of wheels provided on the outer bottom surface of the frame body so as to render the frame body movable.

12. A door exhibit case as claimed in claim 1, further comprising anti-rotation means formed on the inner bottom surface of the frame body for preventing the respective doors from being rotated while being moved.

13. A door exhibit case as claimed in claim 12, wherein the anti-rotation means comprises a plurality of guide grooves formed on the inner bottom surface of the frame body along the front-to-rear direction of the frame body, the bottom portions of the doors being introduced into the guide grooves, respectively.

14. A door exhibit case as claimed in claim 13, further comprising a plurality of wheels provided on the outer bottom surface of the frame body so as to render the frame body movable.

15. A door exhibit case as claimed in claim 1, further comprising a plurality of wheels provided on the outer bottom surface of the frame body so as to render the frame body movable.
